(19) United States
(12) Patent Application Publication
(10) Pub. No.: US 2009/0281367 A1
(43) Pub. Date: Nov. 12, 2009

(54) TRANS-TYMPANIC MEMBRANE TRANSDUCER AND IMPLANTABLE HEARING AID SYSTEM USING THE SAME

(75) Inventors: Jin-Ho Cho, Daegu (KR); Il-Yong Park, Chungcheongnam (KR); Sang-Heun Lee, Daegu (KR); Kyu-yup Lee, Daegu (KR); Myoung-Nam Kim, Daegu (KR); Ki-Woong Seong, Daegu (KR)

Correspondence Address: Emerson, Thomson & Bennett, LLC, 777 W. Market Street, Akron, OH, 44303, US

(73) Assignee: KYUNGPOOK NATIONAL UNIVERSITY INDUSTRY-ACADEMIC COOPERATION FOUNDATION, Daegu (KR)

(21) Appl. No.: 12/261,510

(22) Filed: Oct. 30, 2008

(30) Foreign Application Priority Data
Jan. 9, 2008 (KR) 10-2008-0002461

(51) Int. Cl. H04R 25/00

(52) U.S. Cl. 600/25

(57) ABSTRACT

A trans-tympanic membrane transducer and an implantable hearing aid system using the same. The trans-tympanic membrane transducer vibrates the tympanic membrane using a miniature magnetic member perpendicularly extending through a portion of the tympanic membrane and a coil implanted adjacent to the magnet to generate alternating magnetic field corresponding to sound signal, so as to remarkably improve sound qualities in high frequency bands, which are hardly achievable by a conventional air conduction hearing aid. This overcomes difficulty, inconvenience and risk associated with a conventional operation that implants a miniature magnet on the surface of the tympanic membrane or on an auditory organ such as the ossicle in the middle ear.

### CLAIM OF PRIORITY

This application claims the benefit of Korean Patent Application No. 10-2008-0002461 filed on Jan. 9, 2008, in the Korean Intellectual Property Office, the disclosure of which is incorporated herein by reference.

### BACKGROUND

The present invention relates to a trans-tympanic membrane transducer and an implantable hearing aid system using the same. More particularly, the trans-tympanic membrane transducer of the present invention can vibrate the tympanic membrane using a miniature magnetic member perpendicularly extending through a portion of the tympanic membrane and a coil implanted adjacent to the magnet to generate alternating magnetic field corresponding to sound signal, so as to remarkably improve sound qualities in high frequency bands, which are hardly achievable by a conventional air conduction hearing aid, and can also overcome difficulty, inconvenience and risk associated with a conventional operation that implants a miniature magnet on the surface of the tympanic membrane or on an auditory organ such as the ossicle in the middle ear.

### DESCRIPTION OF THE RELATED ART

About 15% of the world population has mild to severe hearing loss, and a majority of people with hearing loss or hearing impaired people uses a hearing aid. Recent hearing aids have reduced volume, consume less power, and are greatly improved in acoustic performance thanks to the development of semiconductor and digital signal processing technologies.

Particularly, the current hearing aid technologies significantly reduce the possibility of strong sound to be produced from acoustic feedback, which has been regarded as a chronic problem, and also reduce the influence of surrounding noises. Considering reduction in dynamic range according to increase in the hearing threshold of hearing impaired people, custom hearing aids capable of supporting multi-channels can be made suitable to auditory conditions of hearing impaired people. Accordingly, the recent hearing aids satisfy the hearing impaired people better than older types of hearing aids.

However, every person wearing a hearing aid complains of inconvenience without exception. A large number of the hearing impaired people do not wear the hearing aid after he/she purchased it. Statistics report that an elder person more than 65 years old in USA wears a hearing aid for 3 hours or less a day. Owing to the characteristics of a receiver, sound produced by a conventional hearing aid is transmitted with strong intensity generally in a sound range from 500 Hz to 4 kHz, but higher frequency sound significantly loses its gain. Severe distortion occurs in some frequency bands, thereby making it difficult to sufficiently reproduce high frequency sound. Accordingly, the sound of a word is poorly recognizable in noise environments.

In case of senile sensorineural hearing loss, which gets worse in a higher-frequency range, a hearing impaired person tends to turn up volume as an attempt to more clearly hear sound. However, due to the shortage of high frequency components in sound, the person can hear muttering sound only, but fails to recognize a word. Further, when the volume is more turned up, acoustic feedback produces strong sound, which causes pain in the ear. Because of these reasons, the hearing impaired person becomes reluctant to use the hearing aid.

Some types of recent high grade hearing aids are equipped with digital signal processing algorithm for preventing feedback. However, it is impossible to completely prevent feedback since the limit to prevent feedback-induced oscillation is below 15 dB where output sound pressure can return as input. Because of this problem, there are demands for a hearing aid, which not only has excellent high frequency characteristics but also does not produce howling and strong sound by feedback.

To meet such demands, Heide et al. proposed an In The Ear (ITE) hearing aid with a magnet attached on the umbo in 1993. In this ITE hearing aid, a miniature magnet is installed in screw threads, formed in the umbo, where the malleus of three bones of the middle ear is attached to the eardrum, and a coil is fitted to the hearing aid to drive the magnet in the umbo.

This approach involves drilling a hole in the umbo, which has a very small width of 2 mm, and fixing the magnet using a screwed magnet holder. However, these procedures are very difficult even for a skilled otorhinolaryngologist. Further, the umbo is a region in which nerve tissues are distributed and through which body fluids such as blood flow, and thus may suffer from a side effect such as necrosis according to long-term implantation of a foreign substance.

In addition, a U.S. patent to Dormer et al. (assigned to Soundtec, Inc.), 2001, involves disconnecting the incus from the stapes of the middle ear, fitting a loop onto the incus, such that a miniature magnet can be suspended from the loop, connecting again the incus and the stapes, and disposing a magnet-driving coil in the outside, as in Heide et al., so as to drive the miniature magnet.

This technique, however, requires a difficult operation to implant the magnet. Above all, since the distance between the magnet and the outside coil is longer than that of Heide et al., it is required to apply a greater amount of driving current from the hearing aid.

In addition, ReSound, a hearing aid manufacturer in USA, proposed another type of hearing aid in 2000. In this hearing aid, a thin dish of polymer having a magnet in the center thereof is attached, with a diameter less than 5 mm, to the surface of the tympanic membrane by the side of the auditory ear canal, and the tympanic membrane is vibrated using an outside driving coil.

In this technique, however, the magnet has to be closely attached to various types of tympanic membranes of individuals. It is also troublesome to form a contact lens shaped round polymer membrane, customized to the curvature of the tympanic membrane, which is previously measured. Further, oil or like is periodically filled in order to continuously maintain the close attachment.

In order to satisfy these objects, implantable middle ears have been developed in recent years. However, this type of implantable middle ear is a hearing aid that is generally implanted in patients with moderate or severe hearing loss through an operation of two (2) hours or more.

### SUMMARY

The present invention has been made to solve the foregoing problems with the prior art, and therefore at least one embodiment is directed to a trans-tympanic membrane transducer and an implantable hearing aid system. In this system, a miniature magnet is implanted perpendicularly in the little gap or hole incised purposely on the tympanic membrane and after the magnet is fixed through natural healing of the tympanic membrane. Then, AC magnetic field corresponding to sound signal is applied from a position adjacent to the magnet so as to vibrate the tympanic membrane, thereby remarkably improving sound qualities of a receiver, which would otherwise be limited to high frequency band in the prior art.

At least one embodiment is also directed to a trans-tympanic membrane transducer and an implantable hearing aid system capable of overcoming, by one effort, difficulty and inconvenience associated with an operation of the prior art, which implants a miniature magnet or vibrator on the surface of the tympanic membrane or on the auditory organ such as the ossicle in the middle ear.

According to one embodiment, there is provided an implantable transducer, which extends through a tympanic membrane when implanted. The implantable transducer includes a pair of flange covers; a magnetic member coupled between the flange covers; and a casing member coupled between the flange covers with the magnetic member received therein the casing member.

The flange covers may be made of titanium or biocompatible material, and may have a disc-like shape or various shapes suitable for fixing or close attachment to the tympanic membrane.

The casing member may be made of titanium or biocompatible material.

According to another embodiment, there is provided an implantable hearing aid system including a transducer extending through a tympanic membrane. The transducer includes a pair of flange covers; a magnetic member coupled between the flange covers; and a casing member coupled between the flange covers with the magnetic member received therein.

According to a further embodiment, there is provided an implantable hearing aid system, which includes a transducer extending through a tympanic membrane, wherein the transducer comprises a pair of flange covers, a magnetic member coupled between the flange covers, and a casing member coupled between the flange covers with the magnetic member received therein. The implantable hearing aid system also includes an insert unit disposed in an auditory ear canal and spaced apart from the transducer at a predetermined distance, so as to vibrate the transducer in response to output signal supplied from outside; and a hearing aid body connected to the insert unit through a conducting line so as to send the signal to the insert unit.

The insert unit may include a magnet-driving coil supplying alternating magnetic field corresponding to sound signal to the magnetic member of the transducer to vibrate; a connector extending from the magnet-driving coil; and an ear entrance structure disposed on one end of the connector opposite the magnet-driving coil.

The ear entrance structure may have a number of air-holes.

The insert unit may be made of flexible bio-compatible material including plastic, silicone and metal.

The hearing aid body may be disposed on a rear portion of an ear or inside the ear.

According to a still another embodiment, there is provided an implantable hearing aid system, which includes a transducer extending through a tympanic membrane and a totally-implantable hearing aid sending signal to the transducer. The transducer includes a pair of flange covers, a magnetic member coupled between the flange covers and a casing member coupled between the flange covers with the magnetic member received therein. The hearing aid includes an implantable microphone implanted in a temporal bone of a patient body; an implantable hearing aid module body connected to the implantable microphone through a first conducting line; a driving coil fixedly implanted in a middle ear cavity and connected to the implantable hearing aid module body through a second conducting line; and a fixing part including a fixing pin and a fixing bolt to fix the driving coil.

According to another embodiment, there is provided an implantable hearing aid system, which includes a transducer extending through a tympanic membrane and a partially-implantable hearing aid sending signals to the transducer. The transducer includes a pair of flange covers, a magnetic member coupled between the flange covers and a casing member coupled between the flange covers with the magnetic member received therein. The hearing aid includes a hearing aid module body disposed outside the patient body and including a microphone; a receiver receiving the output signal from the hearing aid module body; a driving coil fixedly implanted in a middle ear cavity and connected to the receiver through a conducting line; and a fixing part including a fixing pin and a fixing bolt to fix the driving coil.

The fixing pin and the fixing bolt may be made of titanium.

The flange covers may be made of titanium or biocompatible material.

The casing member may be made of titanium or biocompatible material.

According to yet another embodiment, there is provided an implantable hearing aid system, which includes a floating mass transducer extending through a tympanic membrane, wherein the floating mass transducer includes a coil and a magnetic member, or a piezoelectric vibrator therein. The implantable hearing aid system also includes flange covers fitted to one or both sides of the floating mass transducer; and a conducting line connected to the floating mass transducer.

The implantable hearing aid system may further include a fixing unit fixing the conducting line to a wall of a middle ear cavity.

The trans-tympanic membrane transducer and the implantable hearing aid system using the same according to the present invention have one or more of the following effects.

Firstly, one or a plurality of miniature magnet is implanted perpendicularly to the boundary of the tympanic membrane so as to extend through a portion of the tympanic membrane, and alternating magnetic field corresponding to sound signal is applied using the miniature magnet so as to vibrate the tympanic membrane, thereby increasing the vibration efficiency of high frequency signals. This structure can also overcome the limited frequency quality of a receiver in a conventional hearing aid so as to excellently cope with the hearing loss of high frequency sound, which is most prominent in presbycusis (hearing loss with advancing age).

Secondly, it is much easier, in view of operation, to implant the magnet in the tympanic membrane than in the umbo. This also less damages the ossicle where many veins are present. Even if a relatively larger hole is perforated in the tympanic membrane by the operation, the tympanic membrane quickly recovers to the original state thanks to high healing rate. Since the tympanic membrane quickly recovers when a foreign substance is removed, an operation of restoring the tympanic membrane to the original state can also be carried out when necessary.

Thirdly, the resonance tube of the receiver does not vibrate but the magnet implanted in the tympanic membrane minutely vibrates, such that a very small amount of sound can be radiated from the vibration of the tympanic membrane, so as to fundamentally prevent the hearing aid from producing strong sound due to howling and to enable a high gain operation in which the volume of the hearing aid can be turned up to the maximum. This, as an effect, can compensate for the hearing ability of people with moderate or moderate-severe hearing loss and, in part, of people with severe hearing loss.

Fourthly, the trans-tympanic membrane hearing aid system of the present invention is also applicable to a totally- or partially-implantable middle ear, which uses a floating mass transducer.

Fifthly, a differential magnet can be implanted on the tympanic membrane so as to protect the tympanic membrane from risk such as noise caused by a great external magnetic field.

### BRIEF DESCRIPTION OF THE DRAWINGS

The above and other objects, features and other advantages of the embodiments will be more clearly understood from the following detailed description taken in conjunction with the accompanying drawings, in which:

FIG. 1 illustrates a trans-tympanic membrane transducer according to an embodiment of the present invention, which is implanted to extend through the tympanic membrane;

FIG. 2 is an exploded perspective view of the trans-tympanic membrane transducer of FIG. 1;

FIG. 3 is a perspective view of the trans-tympanic membrane transducer shown in FIG. 1, which is perpendicularly implanted to a boundary portion of the tympanic membrane;

FIG. 4 is a cross-sectional view of FIG. 3;

FIG. 5 illustrates the construction of an implantable hearing aid system having a trans-tympanic membrane transducer according to a first embodiment of the invention;

FIG. 6 illustrates the construction of an implantable hearing aid system having a trans-tympanic membrane transducer according to a second embodiment of the invention;

FIG. 7 illustrates the construction of an implantable hearing aid system having a trans-tympanic membrane transducer according to a third embodiment of the invention;

FIG. 8 illustrates the construction of an implantable hearing aid system having a trans-tympanic membrane transducer according to a fourth embodiment of the invention;

FIG. 9 illustrates comparative experiments using an implantable hearing aid system having a trans-tympanic membrane transducer of at least one of the embodiments and a conventional hearing aid; and

FIG. 10 illustrates the results of comparative experiments using an implantable hearing aid system having a trans-tympanic membrane transducer of at least one of the embodiments and a conventional hearing aid.

### DETAILED DESCRIPTION OF THE EXEMPLARY EMBODIMENTS

Hereinafter, a trans-tympanic membrane transducer and an implantable hearing aid system using the same will be described more fully with reference to the accompanying drawings, in which exemplary embodiments thereof are shown.

Considering the physiological aspect of the tympanic membrane, a hole in the tympanic membrane is sealed within two weeks by the growth of tympanic membrane tissues. When a cylindrical magnet having a diameter of about 2 mm is inserted into a through-hole of the tympanic membrane, it is well fixed to and held in the tympanic membrane.

On the same basis, an otorhinolaryngologist generally removes exudation or foreign material from the middle ear by inserting a small tube made of titanium or biocompatible polymer into the middle ear in order to treat an inflammation or a pathological phenomenon inside the middle ear. Here, the therapeutic tube rarely damages hearing ability.

When the therapeutic tube is maintained in the inserted state for six months or more, the interval between the tube and the tympanic membrane is reduced and the tympanic membrane tissues surround the tube. This creates neither an unprecedented phenomenon nor a problem. In view of operation, it is much easier, to implant the magnet in the tympanic membrane than in the umbo, and the ossicle where many veins are present is less damaged.

Even if a relatively great hole is formed in the tympanic membrane by the operation, the tympanic membrane quickly recovers to the original state thanks to high healing rate. Since the tympanic membrane quickly recovers when a foreign substance is removed, an operation of restoring the tympanic membrane to the original state can also be carried out.

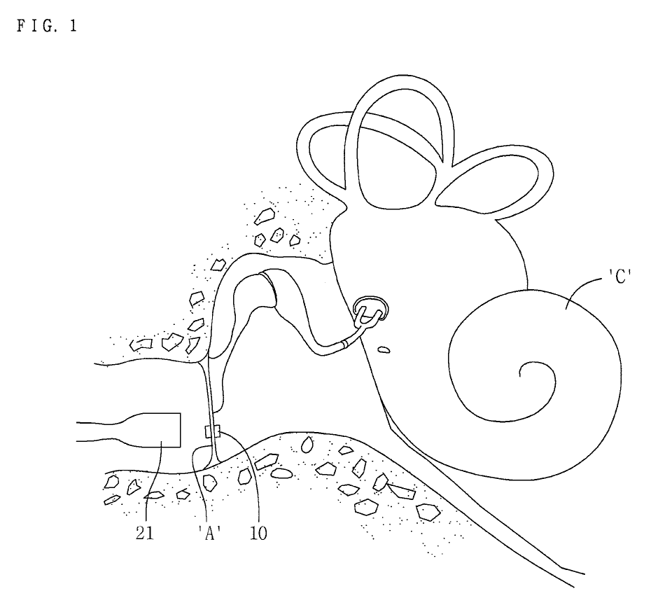

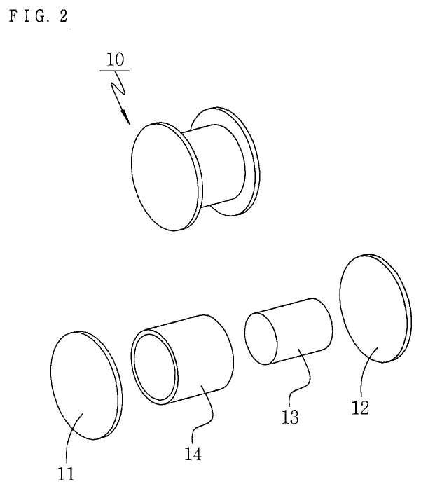

Of the accompanying drawings, FIG. 1 illustrates the trans-tympanic membrane transducer according to an embodiment of the present invention, which is implanted to extend through the tympanic membrane, and FIG. 2 is an exploded perspective view of the trans-tympanic membrane transducer of FIG. 1. Referring to FIGS. 1 and 2, the trans-tympanic membrane transducer 10 of this embodiment includes a pair of flange covers 11 and 12, a magnetic member 13 coupled between the flange covers 11 and 12 and a casing member 14 having the magnetic member 13 inserted therein. The casing member 14 is also coupled between the flange covers 11 and 12. The trans-tympanic membrane transducer 10 is implanted to extend through the tympanic membrane A, in a portion of the tympanic membrane A surrounding the umbo.

The flange covers 11 and 12 are made of the same material as that of the casing member 14, and can be made of titanium or biocompatible material. The flange covers 11 and 12 suitably hold the transducer 10 in a position where the transducer 10 is fitted to the tympanic membrane such that the transducer 10 is not extracted from the tympanic membrane before the transducer 10 is fixed due to natural healing of tympanic membrane.

The magnetic member 13 is a miniature magnet, and is closely received in the cylindrical casing member 14, which is made of titanium or equivalent biocompatible material.

Preferably, the flange covers 11 and 12, the magnetic member 13 and the casing member 14 have a size similar to that of a ventilation tube, which is generally used in otolaryngologic surgery.

The transducer 10 having the above-described construction is implanted into the tympanic membrane A according to the following surgical procedures: Firstly, a portion of the tympanic membrane A is cut by a cutting tool used in otolaryngologic surgery so that the transducer 10 can pass through the cut portion. Next, one of the flange covers 11 and 12 of the transducer 10 is pushed into the cut portion of the tympanic membrane A such that the casing member 14 of the transducer 10 extends through the tympanic membrane A. As described above, the tympanic membrane A can heal from a small surgical wound without a significant aftereffect, thereby sealing the wound in about 2 to 3 weeks, so that the transducer 10 can be naturally fixed to the tympanic membrane A without the use of adhesive or a fixing tool.

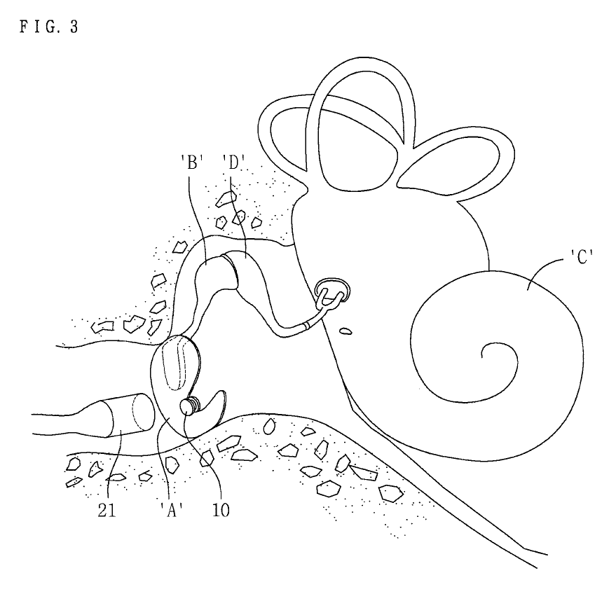

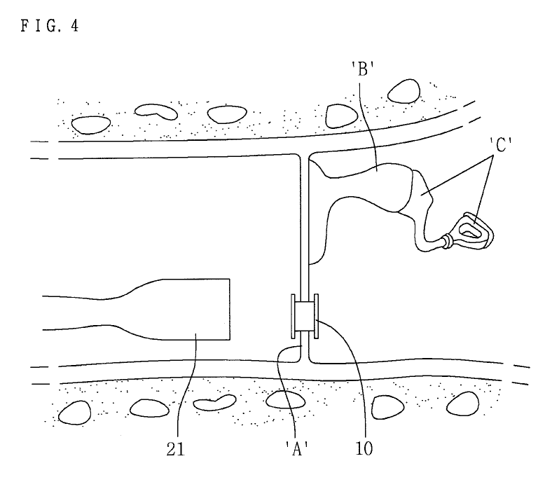

Of the accompanying drawings, FIG. 3 is a perspective view of the trans-tympanic membrane transducer, which is perpendicularly implanted to a boundary portion of the tympanic membrane, and FIG. 4 is a cross-sectional view of FIG. 3. Referring to FIGS. 3 and 4, the transducer 10 is implanted through part of the tympanic membrane A so as to be perpendicular to the boundary portion of the tympanic membrane A. This is distinct from the conventional method in which the magnet is implanted in the umbo. The implanted transducer 10 vibrates in response to alternating magnetic field corresponding to sound signal from a magnet-driving coil 21, which is spaced about 3 to 7 mm from the transducer 10, thereby vibrating the tympanic membrane A. Then, a malleus B connected to the tympanic membrane A also vibrates, thereby transmitting the sound signal to the cochlea C through the ossicle D.

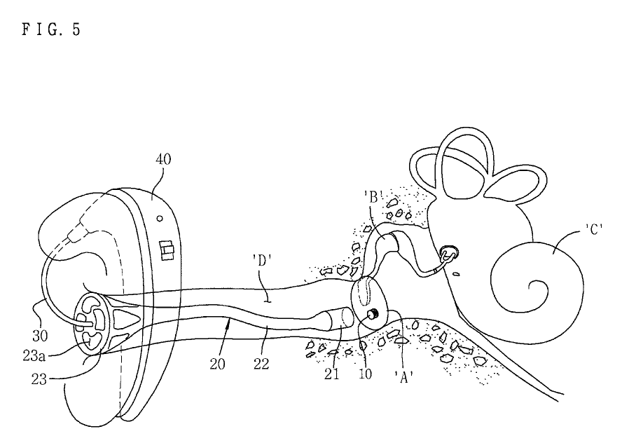

The trans-tympanic membrane transducer used in following first to third embodiments is substantially the same as that shown in FIG. 2, and thus the same or similar reference numerals will be used through FIGS. 5 to 7.

Here, FIG. 5 illustrates the construction of an implantable hearing aid system having a trans-tympanic membrane transducer according to the first embodiment of the invention. Referring to FIG. 5 together with FIG. 2 above, the implantable hearing aid system includes a transducer 10, an insert unit 20 and a hearing aid body 40. The transducer 10 includes, as illustrated above with reference to FIG. 2, a pair of flange covers 11 and 12, a magnetic member 13 and a casing member 14. The insert unit 20 is inserted in the auditory ear canal D, spaced apart from the transducer 10 at a predetermined distance, so as to vibrate the transducer 10 in response to signals supplied from outside. The hearing aid body 40 is connected to the insert unit 20 through a conducting line 30 so as to supply the signals to the insert unit 20.

The flange covers 11 and 12 and the casing member 14 are part of a miniature magnet, and can be made of titanium or equivalent biocompatible material. The flange covers 11 and 12 and the casing member 14 can have various shapes such as a disc or a cylinder, which are suitable for fixing and close attachment to the tympanic membrane.

The insert unit 20 includes a magnet-driving coil 21, which supplies alternating magnetic field corresponding to sound signal to the magnetic member 13 of the transducer 10 so as to vibrate the transducer 10. The insert unit 20 also includes a connector 22 extending from the magnet-driving coil 21 and an ear entrance structure 23 disposed on the outer end of the connector 22.

The ear entrance structure 23 is formed with a number of air-holes 23a. An occlusion effect, which makes hearing aid wearers uncomfortable, can be minimized by forming as many holes as possible.

The insert unit 20 can be made of flexible biocompatible material, such as plastic, silicone or metal.

In the implantable hearing aid system having a trans-tympanic membrane transducer of this embodiment, which is constructed as explained above, signals from the hearing aid body 40 are supplied through the conducting line 30 and then through the connector 22 to the magnet-driving coil 21.

The implantable hearing aid system as described above can increase the vibration efficiency of high frequency signals due to the vibration of the miniature magnet having a small mass. This structure can also overcome the limited frequency quality of a receiver in a conventional hearing aid, and thus can realize a hearing aid that can excellently cope with the hearing loss of high frequency sound, which is most prominent in presbycusis. In addition, the implantable hearing aid system of the first embodiment is applicable not only to Behind The Ear (BTE) hearing aids but also to In The Ear (ITE) hearing aids and Completely In the Canal (CIC) hearing aids.

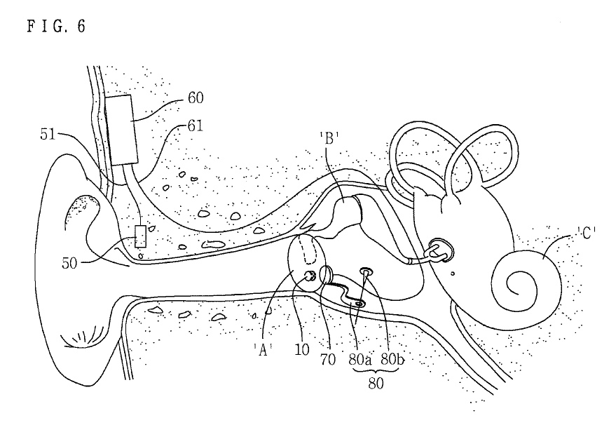

FIG. 6 illustrates the construction of an implantable hearing aid system having a trans-tympanic membrane transducer according to the second embodiment of the invention. Referring to FIG. 6 together with FIG. 2 above, the implantable hearing aid system of this embodiment includes a transducer 10 extending through a tympanic membrane and a totally-implantable hearing aid transmitting sound signal to the transducer 10. The transducer 10 includes, as described above with reference to FIG. 2, a pair of flange covers 11 and 12, a magnetic member 13 and a casing member 14. The totally-implantable hearing aid includes an implantable microphone 50, an implantable hearing aid module body 60, a driving coil 70 and a fixing part 80. The implantable microphone 50 is implanted in a temporal bone of the patient body, and the implantable hearing aid module body 60 is connected to the implantable microphone 50 through a conducting line 51. The driving coil 70 is fixedly implanted in the middle ear cavity, and is connected to the implantable hearing aid module body 60 through a conducting line 61. The fixing part 80 includes a fixing pin 80a and a fixing bolt 80b to fix the driving coil 70.

The flange covers 11 and 12 and the casing member 14 are part of a miniature magnet, and can be made of titanium or equivalent biocompatible material. The fixing pin 80a and the fixing bolt 80b can also be made of titanium, and the driving coil 70 can be disposed just behind the tympanic membrane A, spaced apart at a distance about 1 to 2 mm, by the fixing pin 80a and the fixing bolt 80b.

The size of the driving coil 70 is much smaller than that of the foregoing driving coil 21 (see FIG. 5) in the first embodiment, in order to minimize the distance from the membrane-implantable magnetic member 13.

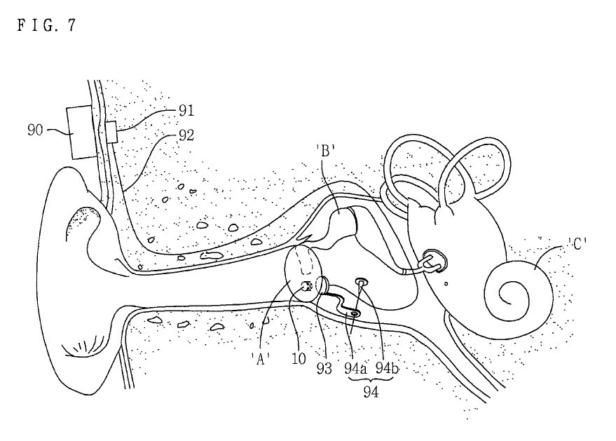

FIG. 7 illustrates the construction of an implantable hearing aid system having a trans-tympanic membrane transducer according to the third embodiment of the invention. Referring to FIG. 7 together with FIG. 2 above, the implantable hearing aid system of this embodiment includes a transducer 10 extending through a tympanic membrane and a partially-implantable hearing aid transmitting sound signal to the transducer 10. The transducer 10 includes, as described above with reference to FIG. 2, a pair of flange covers 11 and 12, a magnetic member 13 and a casing member 14. The partially-implantable hearing aid includes a hearing aid module body 90, a receiver 91, a driving coil 93 and a fixing part 94. The hearing aid module body 90 is disposed outside the patient body, and includes a microphone (not shown). The receiver 91 receives the output signal from the hearing aid module body 90, and the driving coil 93 is fixedly implanted in the middle ear cavity and is connected to the receiver 91 through a conducting line 92. The fixing part 94 includes a fixing pin 94a and a fixing bolt 94b to fix the driving coil 93.

The implantable hearing aid system of this embodiment is substantially the same as the implantable hearing aid system shown in FIG. 6, except that the hearing aid module body 90 including the microphone (not shown) is located outside the human body.

The flange covers 11 and 12 and the casing member 14 are part of a miniature magnet, and can be made of titanium or equivalent biocompatible material. The fixing pin 94a and the fixing bolt 94b can also be made of titanium, and the driving coil 93 can be disposed just behind the tympanic membrane A, spaced apart at a distance about 1 to 2 mm, by the fixing pin 94a and the fixing bolt 94b.

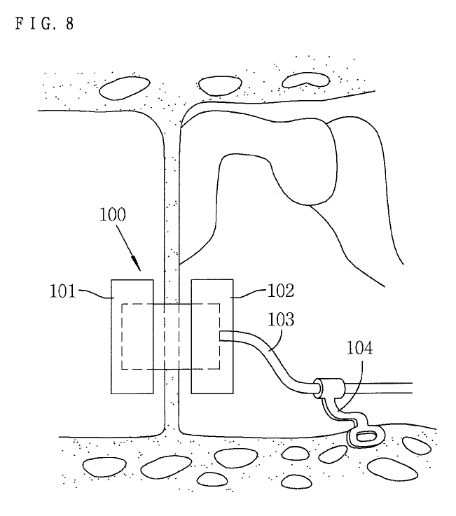

FIG. 8 illustrates the construction of an implantable hearing aid system having a trans-tympanic membrane transducer according to a fourth embodiment of the invention. Referring to FIG. 8 together with FIG. 2, the implantable hearing aid system of this embodiment includes a floating mass transducer 100, a pair of flange covers 101 and 102 attached to one or both sides of the floating mass transducer 100 and a conducting line 103 connected to the floating mass transducer 100. The floating mass transducer 100 includes a coil (not shown) and a magnetic member (not shown) or a piezoelectric vibrator (not shown) therein.

The implantable hearing aid system can further include a fixing member 104, which fixes the conducting line 103 to a wall portion of a middle ear cavity.

The implantable hearing aid system of this embodiment includes a trans-tympanic membrane transducer, as described in any of the foregoing embodiments 1 to 3, or a miniature floating mass transducer 100, which vibrates by itself using internal driving force without an external magnetic field. The floating mass transducer 100 is made of biocompatible material and is implanted through a tympanic membrane A like the foregoing transducer 10.

This is applicable to the case of totally- and partially-implantable middle ear hearing aids, but is not applicable to the case where a hearing aid is disposed outside the human body.

The totally-implantable hearing aid is an apparatus that is totally implanted inside the temporal bone and the middle ear. That is, all components of the totally-implantable hearing aid, including a microphone, a signal processor, a battery module and a miniature transducer, are implanted inside the temporal bone and the middle ear. Particularly, examples of the totally-implantable hearing aid applicable to at least one embodiment may include a floating mass electromagnetic transducer type totally-implantable middle ear or a floating mass piezoelectric transducer type totally-implantable middle ear. The former middle ear directly transmits vibration, caused by the magnetic force between a coil and a magnetic member, to the ossicle. The latter middle ear transmits the expansion and contraction force of a piezoelectric element, caused by voltage driving, to the ossicle.

In the two types of totally-implantable middle ears as described above, the transducer is provided, therein, with a set of a coil and a magnetic member or a piezoelectric element for generating vibration, which can replace a magnet inside the casing when the outer flanges and the casing of the trans-tympanic membrane transducer are used. As an alternative to the construction of this embodiment shown in FIG. 6, the outer coil may not be used. Here, the transducer can be implanted to the tympanic membrane even if it is provided with only the flanges without the casing.

The partially-implantable hearing aid is similar to the above-described totally-implantable hearing aid, except that only the transducer and the signal receiver of components of the hearing aid are implanted in the temporal bone and inside the middle ear but other components such as a microphone, a signal processor and a battery are attached outside so as to be coupled with the implanted components.

The partially-implantable hearing aid applicable to at least one embodiment may be classified into a floating mass electromagnetic transducer type partially-implantable middle ear and a floating mass piezoelectric transducer type partially-implantable middle ear. The former middle ear directly transmits vibration, caused by the magnetic force between a coil and a magnetic member, to the ossicle, whereas the latter middle ear transmits the expansion and contraction force of a piezoelectric element, caused by voltage driving, to the ossicle.

In the two types of partially-implantable middle ears as described above, the transducer is provided, therein, with a set of a coil and a magnetic member or a piezoelectric element for generating vibration, which can replace a magnet inside the casing when the outer flanges and the casing of the trans-tympanic membrane transducer are used. As an alternative to the construction of this embodiment shown in FIG. 7, the outer coil may not be used. Here, the transducer can be implanted to the tympanic membrane even if it is provided with only the flanges without the casing.

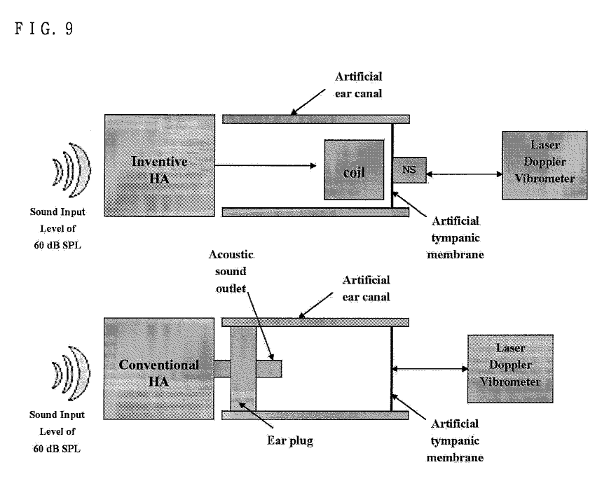

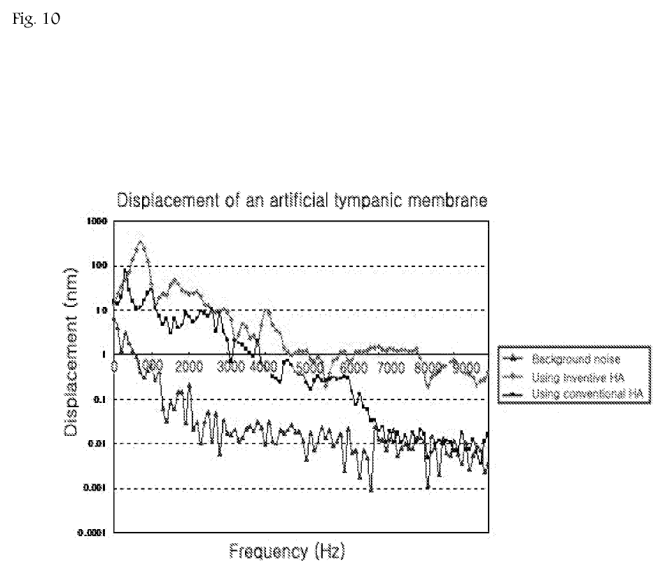

Of the accompanying drawings, FIG. 9 illustrates comparative experiments using an implantable hearing aid system having a trans-tympanic membrane transducer of at least one embodiment and a conventional hearing aid, and FIG. 10 illustrates the results of the comparative experiments of FIG. 9. Considering the length of the auditory ear canal and the size of the tympanic membrane in the human body, a sample of an auditory ear canal and a tympanic membrane was artificially prepared. A trans-tympanic membrane transducer of at least one embodiment was applied to the sample, and the vibration displacement of the tympanic membrane was measured according to frequencies. In addition, a conventional air conduction hearing aid was applied to the sample of the auditory ear canal and the tympanic membrane, and the results were measured. As shown in FIG. 10, the conventional air conduction hearing aid had reduced vibration characteristics in high frequency range or 4 kHz or more, whereas the implantable hearing aid system using the trans-tympanic membrane transducer of at least one embodiment had excellent high frequency characteristics up to 10 kHz.

While the present invention has been described with reference to the particular illustrative embodiments and the accompanying drawings, it is not to be limited thereto but will be defined by the appended claims. It is to be appreciated that those skilled in the art can substitute, change or modify the embodiments in various forms without departing from the scope and spirit of the present invention.

What is claimed is:

1. An implantable transducer comprising:
a pair of flange covers;
a magnetic member coupled between the flange covers; and
a casing member coupled between the flange covers with the magnetic member received therein the casing member,
wherein the transducer extends through a tympanic membrane when implanted.

2. The implantable transducer according to claim 1, wherein the flange covers are made of titanium or biocompatible material, and have a disc-like shape or various shapes suitable for fixing or close attachment to the tympanic membrane.

3. The implantable transducer according to claim 1, wherein the casing member is made of titanium or biocompatible material.

4. An implantable hearing aid system comprising:
a transducer extending through a tympanic membrane,
wherein the transducer comprises a pair of flange covers; a magnetic member coupled between the flange covers; and a casing member coupled between the flange covers with the magnetic member received therein.

5. The implantable hearing aid system according to claim 4, wherein the flange covers are made of titanium or biocompatible material.

6. The implantable hearing aid system according to claim 4, wherein the casing member is made of titanium or biocompatible material.

7. An implantable hearing aid system comprising:
a transducer extending through a tympanic membrane, wherein the transducer comprises a pair of flange covers, a magnetic member coupled between the flange covers, and a casing member coupled between the flange covers with the magnetic member received therein;
an insert unit disposed in an auditory ear canal and spaced apart from the transducer at a predetermined distance, so as to vibrate the transducer in response to signals supplied from outside; and
a hearing aid body connected to the insert unit through a conducting line so as to send the signals to the insert unit.

8. The implantable hearing aid system according to claims 7, wherein the flange covers are made of titanium or biocompatible material.

9. The implantable hearing aid system according to claims 7 wherein the casing member is made of titanium or biocompatible material.

10. The implantable hearing aid system according to claim 7, wherein the insert unit comprises:
a magnet-driving coil supplying alternating magnetic field corresponding to sound signal to the magnetic member of the transducer to vibrate;
a connector extending from the magnet-driving coil; and
an ear entrance structure disposed on one end of the connector opposite the magnet-driving coil.

11. The implantable hearing aid system according to claim 10, wherein the ear entrance structure has a number of air-hole.

12. The implantable hearing aid system according to claim 10, wherein the insert unit is made of flexible bio-compatible material including plastic, silicone and metal.

13. The implantable hearing aid system according to claim 7, wherein the hearing aid body is disposed on a rear portion of an ear or inside the ear.

14. An implantable hearing aid system comprising:
a transducer extending through a tympanic membrane, wherein the transducer comprises a pair of flange covers, a magnetic member coupled between the flange covers and a casing member coupled between the flange covers with the magnetic member received therein; and
a totally-implantable hearing aid sending signals to the transducer, wherein the hearing aid comprises:
an implantable microphone implanted in a temporal bone of a patient body;
an implantable hearing aid module body connected to the implantable microphone through a first conducting line;
a driving coil fixedly implanted in a middle ear cavity and connected to the implantable hearing aid module body through a second conducting line; and
a fixing part including a fixing pin and a fixing bolt to fix the driving coil.

15. The implantable hearing aid system according to claim 14, wherein the fixing pin and the fixing bolt are made of titanium.

16. The implantable hearing aid system according to claims 14, wherein the flange covers are made of titanium or biocompatible material.

17. The implantable hearing aid system according to claims 14, wherein the casing member is made of titanium or biocompatible material.

18. An implantable hearing aid system comprising:
a transducer extending through a tympanic membrane, wherein the transducer comprises a pair of flange covers, a magnetic member coupled between the flange covers and a casing member coupled between the flange covers with the magnetic member received therein; and
a partially-implantable hearing aid sending signals to the transducer, wherein the hearing aid comprises:
a hearing aid module body disposed outside the patient body and including a microphone;
a receiver receiving the output signal from the hearing aid module body;
a driving coil fixedly implanted in a middle ear cavity and connected to the receiver through a conducting line; and
a fixing part including a fixing pin and a fixing bolt to fix the driving coil.

19. The implantable hearing aid system according to claim 18, wherein the fixing pin and the fixing bolt are made of titanium.

20. The implantable hearing aid system according to claims 18, wherein the flange covers are made of titanium or biocompatible material.

21. The implantable hearing aid system according to claims 18, wherein the casing member is made of titanium or biocompatible material.

22. An implantable hearing aid system comprising:
a floating mass transducer extending through a tympanic membrane, wherein the floating mass transducer comprises a coil and a magnetic member, or a piezoelectric vibrator therein;
flange covers fitted to one or both sides of the floating mass transducer; and
a conducting line connected to the floating mass transducer.

23. The implantable hearing aid system according to claim 22, further comprising a fixing unit fixing the conducting line to a wall of a middle ear cavity.
